(19) United States
(12) Patent Application Publication
(10) Pub. No.: US 2026/0012767 A1
(43) Pub. Date: Jan. 8, 2026

(54) MACHINE IDENTIFICATION SYSTEM AND METHOD

(71) Applicant: Oshkosh Corporation, Oshkosh, WI (US)

(72) Inventors: Korry D. KOBEL, Oshkosh, WI (US); Fredric L. Yutzy, Oshkosh, WI (US); Dan Adamson, Oshkosh, WI (US)

(73) Assignee: Oshkosh Corporation, Oshkosh, WI (US)

(21) Appl. No.: 19/323,624

(22) Filed: Sep. 9, 2025

Related U.S. Application Data
(63) Continuation of application No. PCT/US2024/019174, filed on Mar. 8, 2024.
(60) Provisional application No. 63/489,558, filed on Mar. 10, 2023.
(60) Provisional application No. 63/489,538, filed on Mar. 10, 2023.
(60) Provisional application No. 63/489,533, filed on Mar. 10, 2023.
(60) Provisional application No. 63/451,387, filed on Mar. 10, 2023.
(60) Provisional application No. 63/451,351, filed on Mar. 10, 2023.
(60) Provisional application No. 63/489,562, filed on Mar. 10, 2023.
(60) Provisional application No. 63/451,390, filed on Mar. 10, 2023.
(60) Provisional application No. 63/451,504, filed on Mar. 10, 2023.
(60) Provisional application No. 63/451,506, filed on Mar. 10, 2023.
(60) Provisional application No. 63/489,560, filed on Mar. 10, 2023.
(60) Provisional application No. 63/451,342, filed on Mar. 10, 2023.
(60) Provisional application No. 63/489,531, filed on Mar. 10, 2023.

(51) Int. Cl. H04W 4/70; H04W 4/021; H04W 84/18

(52) U.S. Cl. CPC H04W 4/70; H04W 4/021; H04W 84/18

(57) ABSTRACT

A method of identifying a machine. The method includes receiving at least one attribute from a plurality of attributes associated with a lift device and receiving a threshold value of the attribute. The method further includes locating at least one lift device within a predefined area that is associated with the at least one attribute. The method further includes receiving a value of the at least one attribute associated with the lift device and determining if the value satisfies the threshold value of the attribute. Upon determining that the value satisfies the threshold value, the method includes transmitting instructions to indicate that the value satisfies the threshold value of the attribute.

### CROSS-REFERENCE TO RELATED APPLICATIONS

This application is a continuation of International Application No. PCT/US2024/019174, filed Mar. 8, 2024, which claims the benefit of and priority to (i) U.S. Provisional Application No. 63/451,342, filed on Mar. 10, 2023, (ii) U.S. Provisional Application No. 63/451,351, filed on Mar. 10, 2023, (iii) U.S. Provisional Application No. 63/451,387, filed on Mar. 10, 2023, (iv) U.S. Provisional Application No. 63/451,390, filed on Mar. 10, 2023, (v) U.S. Provisional Application No. 63/489,533, filed on Mar. 10, 2023, (vi) U.S. Provisional Application No. 63/451,504, filed on Mar. 10, 2023, (vii) U.S. Provisional Application No. 63/489,562, filed on Mar. 10, 2023, (viii) U.S. Provisional Application No. 63/451,506, filed on Mar. 10, 2023, (ix) U.S. Provisional Application No. 63/489,531, filed on Mar. 10, 2023, (x) U.S. Provisional Application No. 63/489,538, filed on Mar. 10, 2023, (xi) U.S. Provisional Application No. 63/489,558, filed on Mar. 10, 2023, and (xii) U.S. Provisional Application No. 63/489,560, filed on Mar. 10, 2023, each of which is hereby incorporated by reference herein in its entirety.

### BACKGROUND

Work equipment such as lifts and telehandlers sometimes require tracking, tasking, monitoring, locating, identifying, and servicing at a worksite or rental lot. Managers and operators of work equipment typically rely on discrete systems, applications, and methods to perform these functions for each piece of equipment.

### SUMMARY

In some aspects, the techniques described herein relate to a computer-implemented method of identifying a machine, including: receiving, by a server, an attribute from a plurality of lift device attributes; receiving, by the server, a threshold value of the attribute; locating, by the server, a lift device within a predefined area, wherein the lift device is associated with the attribute; receiving, by the server, a value of the attribute associated with the lift device; determining, by the server, if the value satisfies the threshold value of the attribute; and in response to determining, by the server, that the value satisfies the threshold value, transmitting, by the server, instructions to the lift device to indicate that the value satisfies the threshold value of the attribute by at least one of: indicating by an indicator associated with the lift device; or identifying the lift device on an electronic device.

In some aspects, the techniques described herein relate to a computer-implemented method, wherein the plurality of lift device attributes includes at least one of a charging status, a charge level, a fuel level, a trouble code, a machine type, a machine reach, a machine age, and a machine operating hours.

In some aspects, the techniques described herein relate to a computer-implemented method, wherein the predefined area is determined by a local mesh network.

In some aspects, the techniques described herein relate to a computer-implemented method, wherein identifying the lift device on the electronic device includes highlighting the lift device on a map displayed on the electronic device.

In some aspects, the techniques described herein relate to a computer-implemented method, wherein locating at least one lift device further includes: transmitting, by the server, a request to one or more machines communicatively coupled to the server by a local mesh network for one or more attributes associated with the one or more machines; in response to receiving, by the server, one or more attributes associated with the one or more machines, determining, by the server, if the one or more attributes associated with the one or more machines corresponds to the attribute received by the server; and receiving, by the server, from the one or more machines, a location corresponding to each of the one or more machines.

In some aspects, the techniques described herein relate to a computer-implemented method, wherein the indicator associated with the lift device is one of an audio emitter, a light emitter, and a haptic emitter.

In some aspects, the techniques described herein relate to a computer-implemented method, further including: in response to determining, by the server, that the value does not satisfy the threshold value, transmitting, by the server, instructions to the lift device to indicate that the value does not satisfy the threshold value of the attribute by at least one of: indicating by the indicator associated with the lift device; or identifying the lift device on the electronic device.

In some aspects, the techniques described herein relate to a system including: a lift device; a user device; and one or more processors configured to execute steps including: receiving from the user device an attribute from a plurality of lift device attributes; receiving from the user device a threshold value of the attribute; locating the lift device within a predefined area, wherein the lift device is associated with the attribute; receiving from the lift device a value of the attribute associated with the lift device; determining if the value satisfies the threshold value of the attribute; and in response to determining that the value satisfies the threshold value, transmitting instructions to the lift device to indicate that the value satisfies the threshold value of the attribute by at least one of: indicating by an indicator associated with the lift device; and identify the lift device on an electronic device.

In some aspects, the techniques described herein relate to a system, wherein the plurality of lift device attributes includes at least one of a charging status, a charge level, a fuel level, a trouble code, a machine type, a machine reach, a machine age, and a machine operating hours.

In some aspects, the techniques described herein relate to a system, wherein the predefined area is determined by a local mesh network.

In some aspects, the techniques described herein relate to a system, wherein identifying the lift device on the electronic device includes highlighting the lift device on a map displayed on the electronic device.

In some aspects, the techniques described herein relate to a system, wherein locating the lift device further includes: transmitting a request to one or more machines communicatively coupled by a local mesh network for one or more attributes associated with the one or more machines; in response to receiving one or more attributes associated with the one or more machines, determining if the one or more attributes associated with the one or more machines corresponds to the attribute received; and receiving from the one or more machines a location corresponding to each of the one or more machines.

In some aspects, the techniques described herein relate to a system, wherein the indicator associated with the lift device is one of an audio emitter, a light emitter, and a haptic emitter.

In some aspects, the techniques described herein relate to a system, further including: in response to determining that the value does not satisfy the threshold value, transmitting, by the one or more processors, instructions to the lift device to indicate that the value does not satisfy the threshold value of the attribute by at least one of: indicating by the indicator associated with the lift device; and identifying the lift device on the electronic device.

In some aspects, the techniques described herein relate to a computer-readable medium including a non-transitory storage memory configured to store machine-readable instructions that when executed by a processor instruct the processor to: receive an attribute from a plurality of lift device attributes; receive a threshold value of the attribute; locate a lift device within a predefined area, wherein the lift device is associated with the attribute; receive a value of the attribute associated with the lift device; determine if the value satisfies the threshold value of the attribute; and in response to determining that the value satisfies the threshold value, transmit instructions to the lift device to indicate that the value satisfies the threshold value of the attribute by at least one of: indicating by an indicator associated with the lift device; and identifying the lift device on an electronic device.

In some aspects, the techniques described herein relate to a computer-readable medium, wherein the plurality of lift device attributes includes at least one of a charging status, a charge level, a trouble code, a machine type, a machine reach, a machine age, and a machine operating hours.

In some aspects, the techniques described herein relate to a computer-readable medium, wherein the predefined area is determined by a local mesh network.

In some aspects, the techniques described herein relate to a computer-readable medium, wherein identifying the lift device on the electronic device includes highlighting the lift device on a map displayed on the electronic device.

In some aspects, the techniques described herein relate to a computer-readable medium, wherein locating at least one lift device further includes: transmitting a request to one or more machines communicatively coupled by a local mesh network for one or more attributes associated with the one or more machines; in response to receiving one or more attributes associated with the one or more machines, determining if the one or more attributes associated with the one or more machines corresponds to the attribute received; and receiving from the one or more machines a location corresponding to each of the one or more machines.

In some aspects, the techniques described herein relate to a computer-readable medium, wherein the indicator associated with the lift device is one of an audio emitter, a light emitter, and a haptic emitter.

### BRIEF DESCRIPTION OF THE FIGURES

FIG. 1 is a schematic representation of a work machine including a machine control module according to some embodiments.

FIG. 2 is a schematic representation of a local fleet connectivity system, according to some embodiments.

FIG. 3 is a schematic representation of a local fleet connectivity system with a central integration module, according to some embodiments.

FIG. 4 is a schematic representation of a worksite and equipment staging area with a local fleet connectivity system deployed, according to some embodiments.

FIG. 5 is a picture representation of a worksite with a local fleet connectivity system connecting two pieces of equipment, according to some embodiments.

FIG. 6 is a picture representation of a piece of equipment with a local fleet connectivity system providing connectivity to a remote user, according to some embodiments.

FIG. 7 is a schematic representation of a worksite with a local fleet connectivity system deployed with connectivity to off-site systems, according to some embodiments.

FIG. 8 is a picture representation of an apparatus configured with a local fleet connectivity system, according to some embodiments.

FIG. 9 is a graphical user interface of the local fleet connectivity system of FIG. 2, according to some embodiments.

FIG. 10 is a picture representation of a work machine with machine-specific output data connected to the local fleet connectivity system of FIG. 2

FIG. 11 is a picture representation of work machines configured for use in the local fleet connectivity system of FIG. 2.

FIG. 12 is a picture representation of a work machine provisioned with an integrated connectivity module and beacon, according to some embodiments.

FIG. 13 is a drawing representing a view of a user interface of a multiple-machine identification system, according to some embodiments.

FIG. 14 is a drawing of another view of the user interface of the multiple machine identification system of FIG. 13, according to some embodiments.

FIG. 15 is a flow diagram of a method for identifying a machine that meets a user's search criteria.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Users of work equipment such as lifts and telehandlers sometimes desire to find a specific machine within a large group of machines based on a specific set of criteria. It is therefore desirable to provide a means to quickly and effectively identify a machine to assist a user in identifying a particular machine or a group of machines that match the specific set of criteria and the status or state of each machine, thereby saving time, improving efficiency, and reducing costs. It is also desirable to quickly identify and enable connected services for a particular work machine from a group of machines at a worksite.

Referring to the figures generally, various exemplary embodiments disclosed herein relate to systems and methods for identifying at least one machine connected to a local fleet connectivity system. For example, an available machine identification system may include work machines configured with connectivity modules that may illuminate lights or generate sounds with a beacon or with the horn and lights of the machine itself when a user interacts with an application (e.g., an “identify my machine” application, an “identify available machines near me” application, etc.). In some embodiments, the machines may include an audio emitter, a light emitter, and/or a haptic emitter to generate identifying cues for a user. For example, the audio emitter may emit audible or inaudible sound wavelengths, the light emitter may emit visible or invisible light wavelengths, and the haptic emitter may emit haptic feedback (e.g., vibrations). The available machine identification system may visually or audibly identify machines in a user-selected group of machines at a worksite. Alternatively, the group of machines may be determined by machines connected to a local wireless mesh network. In this way, machines may be selected based on a geographical location. Using the beacons on the machines or the lights and horns of the machines, several machines can be identified at a time both digitally in an application and on the machine itself. In other embodiments, a single machine may be indicated. The available machine identification system allows a user to pick a machine physically and tie it to the digital version of the machine stored in the available machine identification system or in a local fleet connectivity system with a multiple-machine identification capability. The available machine identification system may save time searching for serial numbers and matching them to machines and documents. In another example, the machine identification system may use beacon lights and beep the horns of machines in a group of machines at a worksite or rental lot to differentiate one machine from another. A user may use the available machine identification system to ensure the selection of local machines (e.g., machines within a distance of the user or within a distance of a task on a worksite) that fit a user-defined criteria (e.g., charge level, charging, fuel level, no trouble codes, machine type, machine reach, machine age, machine operating hours, machine that is easiest to pull out of a staging area, machine with required hand and power tools stored therein).

Further referring generally to the figures, various exemplary embodiments disclosed herein relate to systems and methods (e.g., computer-implemented methods) for interactivity and productivity that may enhance local fleet connectivity. For example, Bluetooth Low Energy (BLE) Machine-to-machine (M2M) communication protocols may be used to expand communication at a worksite/jobsite via local connectivity between machines at the worksite/jobsite. In some embodiments, a local fleet connectivity system may include various work machines, interface modules, worksite equipment, communications devices, communications networks, user interface devices, devices hosting local fleet connectivity system software, and user interfaces. Local fleet connectivity system users may include equipment users, equipment maintainers, equipment suppliers, worksite/jobsite supervisors, remote users, etc. The information provided to the local fleet connectivity system may be communicated to users via a user interface. In some embodiments, the user interface may include a real-time map, showing a current machine location, and a machine status. In some embodiments, the user interface includes a color-coded warning indicator, an audible alarm, or another indicator structured to communicate to the machine operator that the work machine is in a location or state that requires the attention of the operator.

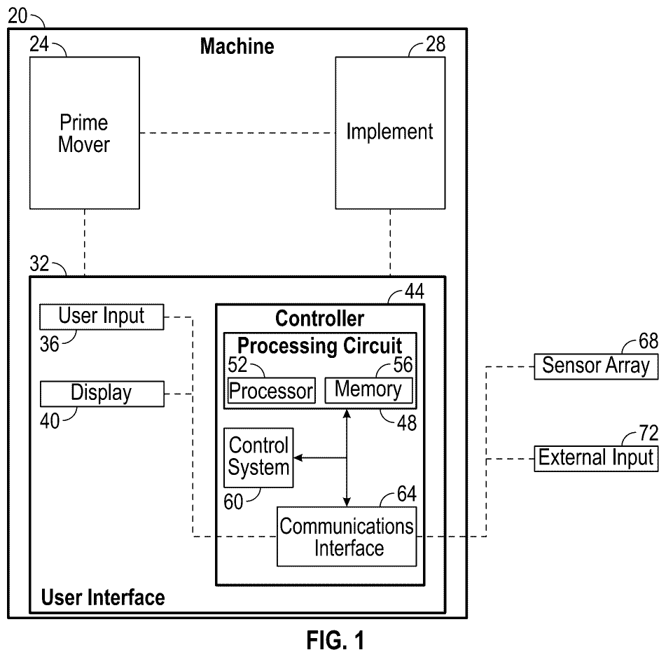

As shown in FIG. 1, a work machine 20 (e.g., a telehandler, a boom lift, a scissor lift, etc.) includes a prime mover 24 (e.g., a spark ignition engine, a compression ignition engine, an electric motor, a generator set, a hybrid system, etc.) structured to supply power to the work machine 20, and an implement 28 driven by prime mover 24. In some embodiments, the implement 28 is a lift boom, a scissor lift, a telehandler arm, etc.

A user interface 32 is arranged in communication with the prime mover 24 and the implement 28 to control operations of the work machine 20 and includes a user input 36 that allows a machine operator to interact with the user interface 32, a display 40 for communicating to the machine operator (e.g., a display screen, a lamp or light, an audio device, a dial, or another display or output device), and a control module 44.

As the components of FIG. 1 are shown to be embodied in the work machine 20, the controller 44 may be structured as one or more electronic control units (ECU). The controller 44 may be separate from or included with at least one of an implement control unit, an exhaust after-treatment control unit, a powertrain control module, an engine control module, etc. In some embodiments, the control module 44 includes a processing circuit 48 having a processor 52 and a memory device 56, a control system 60, and a communications interface 64. Generally, the control module 44 is structured to receive inputs and generate outputs for or from a sensor array 68 and external inputs or outputs 72 (e.g., a load map, a machine-to-machine communication, a fleet management system, a user interface, a network, etc.) via the communications interface 64.

The control system 60 generates a range of inputs, outputs, and user interfaces. The inputs, outputs, and user interfaces may be related to a jobsite, a status of a piece of equipment, environmental conditions, equipment telematics, an equipment location, task instructions, sensor data, equipment consumables data (e.g., a fuel level, a condition of a battery), status, location, or sensor data from another connected piece of equipment, communications link availability and status, hazard information, positions of objects relative to a piece of equipment, device configuration data, part tracking data, text and graphic messages, weather alerts, equipment operation, maintenance, and service data, equipment beacon commands, tracking data, performance data, cost data, operating and idle time data, remote operation commands, reprogramming and reconfiguration data and commands, self-test commands and data, software as a service data and commands, advertising information, access control commands and data, onboard literature, machine software revision data, fleet management commands and data, logistics data, equipment inspection data including inspection of another piece of equipment using onboard sensors, prioritization of communication link use, predictive maintenance data, tagged consumable data, remote fault detection data, machine synchronization commands and data including cooperative operation of machines, equipment data bus information, operator notification data, work machine twinning displays, commands, and data, user wearable alerts, collision alerts, etc.

The sensor array 68 can include physical and virtual sensors for determining work machine states, work machine conditions, work machine locations, loads, and location devices. In some embodiments, the sensor array includes a GPS device, a LIDAR location device, inertial navigation, or other sensors structured to determine a position of the equipment 20 relative to locations, maps, other equipment, objects or other reference points.

In one configuration, the control system 60 is embodied as machine or computer-readable media that is executable by a processor, such as processor 52. As described herein and amongst other uses, the machine-readable media facilitates the performance of certain operations to enable reception and transmission of data. For example, the machine-readable media may provide an instruction (e.g., command, etc.) to, e.g., acquire data. In this regard, the machine-readable media may include programmable logic that defines the frequency of acquisition of the data (or, transmission of the data). The computer-readable media may include code, which may be written in any programming language including, but not limited to, Java or the like, and any conventional procedural programming languages, such as the “C” programming language or similar programming languages. The computer-readable program code may be executed on one processor or multiple remote processors. In the latter scenario, the remote processors may be connected to each other through any type of network (e.g., CAN bus, etc.).

In another configuration, the control system 60 is embodied as hardware units, such as electronic control units. As such, the control system 60 may be embodied as one or more circuitry components including, but not limited to, processing circuitry, network interfaces, peripheral devices, input devices, output devices, sensors, etc. In some embodiments, the control system 60 may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the control system 60 may include any type of component for accomplishing or facilitating the achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on). The control system 60 may also include programmable hardware devices such as field programmable gate arrays, programmable array logic, programmable logic devices, or the like. The control system 60 may include one or more memory devices for storing instructions that are executable by the processor(s) of the control system 60. The one or more memory devices and processor(s) may have the same definition as provided below with respect to the memory device 56 and processor 52. In some hardware unit configurations, the control system 60 may be geographically dispersed throughout separate locations in the machine. Alternatively, and as shown, the control system 60 may be embodied in or within a single unit/housing, which is shown as the controller 44.

In the example shown, the control module 44 includes the processing circuit 48 having the processor 52 and the memory device 56. The processing circuit 48 may be structured or configured to execute or implement the instructions, commands, and/or control processes described herein with respect to control system 60. The depicted configuration represents the control system 60 as machine or computer-readable media. However, as mentioned above, this illustration is not meant to be limiting as the present disclosure contemplates other embodiments where the control system 60, or at least one circuit of the control system 60, is configured as a hardware unit. All such combinations and variations are intended to fall within the scope of the present disclosure.

The hardware and data processing components used to implement the various processes, operations, illustrative logics, logical blocks, modules, and circuits described in connection with the embodiments disclosed herein (e.g., the processor 52) may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, any conventional processor, or a state machine. A processor also may be implemented as a combination of computing devices, such as a combination of a DSP and a microprocessor, a plurality of microprocessors, one or more microprocessors in conjunction with a DSP core, or any other such configuration. In some embodiments, the one or more processors may be shared by multiple circuits (e.g., control system 60 may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The memory device 56 (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory device 56 may be communicably connected to the processor 52 to provide computer code or instructions to the processor 52 for executing at least some of the processes described herein. Moreover, the memory device 56 may be or include tangible, non-transient volatile memory or non-volatile memory. Accordingly, the memory device 56 may include database components, object code components, script components, or any other type of information structure for supporting the various activities and information structures described herein.

In an exemplary embodiment, the memory device 56 stores instructions for execution by the processor 52 for a process to automatically generate a worksite equipment grouping. The process to automatically generate a worksite equipment grouping automatically associates machines 20 connected on a near network to one or more other machines 20. In some embodiments, the automatic associations are based on rule stored on a work machine or on another network node. In some embodiments, the association rules are based on one or more of a worksite designation, a location of a machine, or a code (e.g., a customer key, a manufacturer key, or a maintainer key).

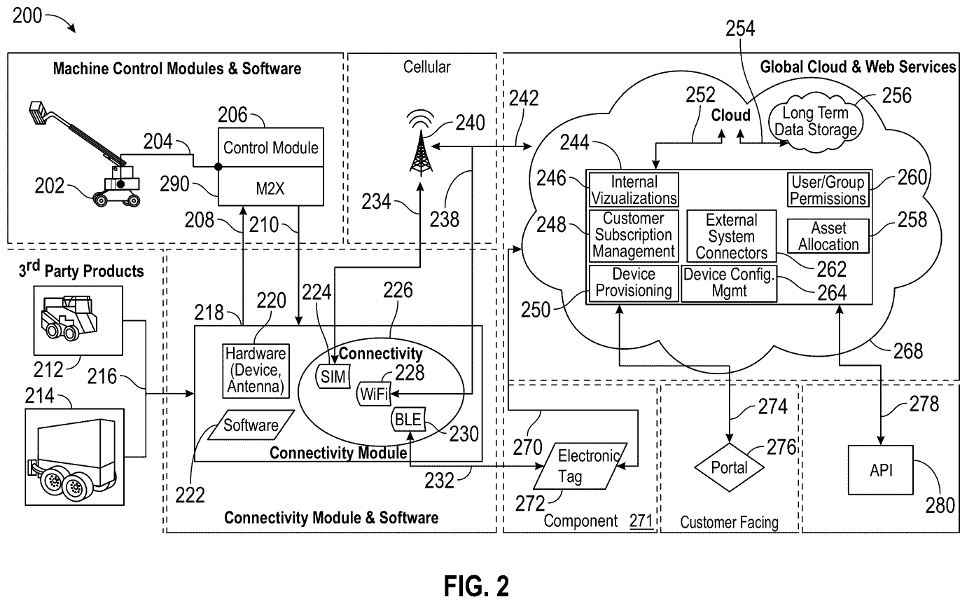

As shown in FIG. 2, the local fleet connectivity system 200 is supported by a network of nodes. The network of nodes may include one or more work machines 202, each with a control module 206, one or more connectivity modules 218, and one or more network devices hosting, for example, user devices 272 including user interfaces, network portals 276, application interfaces/application programming interfaces 280, data storage systems 256, cloud and web services, and product development tool and application hubs 244.

The work machine 202 is communicably connected to a control module 206. The connection 204 between the work machine 202 and the control module 206 may be wired or wireless thus providing the flexibility to integrate the control module with the work machine 202 or to temporarily attach the control module 206 to the work machine 202. The control module 206 may be configured or may be reconfigurable in both hardware and software to interface with a variety of work machines 202, 212, 214 via the connectivity module 218. The control module 206 may comprise an integral power source or may draw power from the work machine 202 or another external source of power. Control modules 206 may be installed on or connected, e.g., via a connection 216, to products (e.g., third-party products 212, 214) not configured by the original product manufacturer with a control module 206.

The work machine 202 communicably connects to the local fleet connectivity system 200 via a machine-to-X (M2X) module 290. The M2X module 290 is communicably connected to the control module 206. The M2X module 290 establishes one or more communications channels 208, 210 with a connectivity module 218. The connectivity module 218 provides a plurality of links between one or more work machines 202, 212, 214 and the local fleet connectivity system 200. Applications providing functions for the local fleet connectivity system 200 may be run by the M2X modules on one or more work machines 202. One or more user devices 272 may be configured to communicate (e.g., to exchange commands, codes (e.g., a customer key) and data) with the connectivity modules of one or more machines via a network connection, for example via a local wireless connectivity system or via cellular networks (e.g., via cell towers 240) to form a network of interconnections among machines, devices, or nodes. Connections between machines and user devices in the local fleet connectivity system 200 may be provided by a wireless mesh network, for example.

The connectivity module 218 comprises hardware 220, further comprising antennas, switching circuits, filters, amplifiers, mixers, and other signal processing devices for a plurality of wavelengths, frequencies, etc., software hosted on a non-volatile memory components 222, and a communications manager 226. The communications manager 226 may comprise processing circuits with communications front ends 224, 228, and 230 for one or more signal formats and waveforms including, for example, Bluetooth, Bluetooth low energy, Wi-Fi, cellular, optical, and satellite communications. The connectivity module 218 may function as a gateway device connecting work machine 202 to other work machines 212, 214, remote computing systems 244, 272, 276, and 280, beacons, scheduling, or other fleet management and coordination systems.

The local fleet connectivity system 200 allows for the coordination of multiple machines 202, 212, 214 within the same worksite, or a fleet-wide control. For example, a work machine 202 may remotely report the results of a self-inspection to a user via a user device 272.

The local fleet connectivity system 200 provides connectivity between work machines 202, 212, 214 and user devices 272 including remotely hosted user interfaces, network portals 276, application interfaces/application programming interfaces 280, data storage systems 256, cloud and web services 268, and product development tool and application hubs 244 that function as an Internet of Things (IoT) system for operation, control, and support of work machines 202, 212, 214 and users of work machines. Connections 232, 234, 238, 242, 252, 254, 270, 274, and 278 between nodes connected to the local fleet connectivity system 200 may comprise, for example, cellular networks (e.g., via cell towers 240), or other existing or new means of digital connectivity.

Product development tool and application hubs 244 may comprise tools and applications for internal visualizations 246, customer subscription management 248, device provisioning 250, external systems connectors 262, device configuration management 264, user/group permissions 260, asset allocation 258, fleet management, compliance, etc.

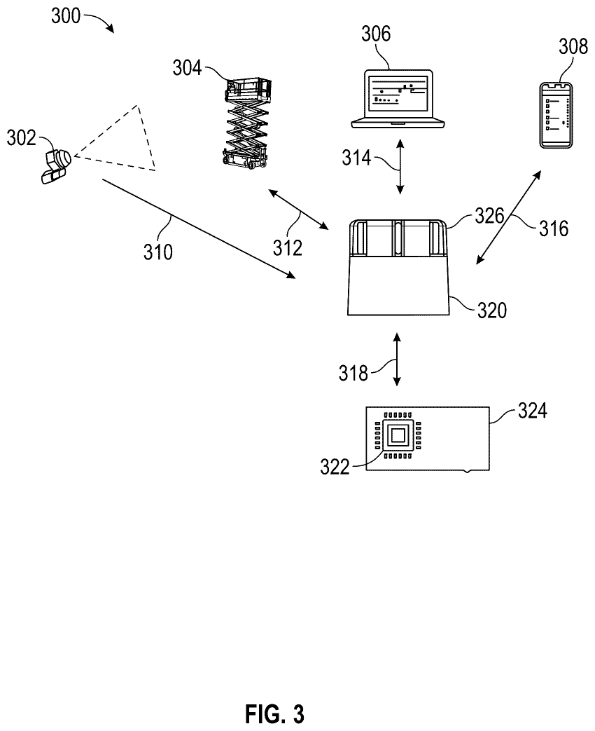

FIG. 3 shows a local fleet connectivity system 300 according to an exemplary embodiment. As shown in FIG. 3, the connectivity module 320 is communicably connected to a machine controller and functions as a communications interface between a control system 322 of the work machine 324 and other elements connected to the local fleet connectivity system 300. The connectivity module 320 may be part of the work machine 324 or may be physically coupled to the work machine 324. The connectivity module 320 may exchange commands and data 318 with the control system 322 of the work machine 324, sensor data 310 with auxiliary sensors 302, machine data 312 with another machine 304, sensor data with another machine 304, commands and data 314 with a node or portal 306, and commands and data 316 with a user device 308 running an application for the local fleet connectivity system 300. The connectivity module 320 may exchange commands, codes (e.g., a customer key), and data between work machines 304, 324, user devices 308, and/or nodes 306 to form a network of interconnections among machines, devices, or nodes.

In some embodiments, the connectivity module 320 is communicatively connected to a light attached to a work machine. The light may be a work machine light (e.g., a headlight) or a beacon 326 (e.g., an RGB LED light) coupled to the connectivity module 320. In some embodiments, the light is configured to emit light in one or more colors, intensities, patterns, etc. In some embodiments, the connectivity module illuminates the light responsive to a command from a remote user device communicatively connected to the connectivity module via a wireless connection. In some embodiments, the user device transmits the command to illuminate the work machine light responsive to user interaction with a local fleet connectivity application hosted on the user device. In some embodiments, the connectivity module illuminates the light and activates an audible indicator responsive to the command from the remote user device. In some embodiments, visual and audible indicators may be used in conjunction or independently of one another. In some embodiments, a plurality of connectivity modules illuminates the lights attached to a plurality of work machines responsive to a command from a remote user device communicatively connected to the plurality of connectivity modules via a wireless connection. In some embodiments, the plurality of lights attached to the plurality of work machines are illuminated simultaneously in response to a single command from the remote user device. In some embodiments, the local fleet connectivity system generates commands to a plurality of work machines designated by a user interacting with the local fleet connectivity application hosted on a user device to activate lights or audible indicators and electronically pair a work machine selected by a user from the plurality of work machines with a digital model of the selected work machine-generated by the local fleet connectivity application on the user device. For example, a user may observe a group of work machines at a worksite. The user may command a subset of the group of work machines to activate lights on or attached to the work machines using an application on a user device (e.g., a “find me” application). The user may, through the user application, designate the subset of work machines to be identified based on criteria selected through the application. Through the application and user device connected to work machines on the local fleet connectivity network 300, the user may activate lights, horns, or other indicators on several different work machines and may select variations on lights (e.g., different colors, different patterns, different intensities, etc.) to distinguish between machines and quickly identify the desired machine or group of machines (e.g., “find me” commands to multiple machines at the same time). The application provides options for a user to identify a machine physically (through observation of the light or a horn) and tie the identified machine to the digital model of the same machine-generated by the application on the user device. For example, a user may tie a selected machine or group of machines identified physically by the user using the “find me” indications with a digital record for the machine (including serial number, service records), and access connected services for the machine available through the local fleet connectivity system (e.g., location, electronic commerce, use tracking, billing, maintenance support, etc.). In a further example, a user may apply additional criteria to machine identification commands. For example, a user input to the application criteria for machine states or conditions (e.g., fully charged, at least ½ fuel, no outstanding service issues, no faults detected on self-test, etc.), machine type (e.g., specific make, specific model, etc.), machine location (e.g., proximity to the user, proximity to a task, positioned for easiest movement out of a staging area, etc.). The provisions within the local fleet connectivity application and network for physically identifying machines and tying them to matching digital models including full digital machine records provide significant savings of time searching machines and manually confirming records (e.g., machine serial numbers). In a further example, a user may simultaneously communicate with a plurality of machines (e.g., directly using a mesh, Wi-Fi, or other local connection or remotely via a cloud network connection) that satisfy one or more selected criteria (e.g., machines that are the same model) and command them via the local fleet connectivity application to separately identify themselves (e.g., with different color lights). The user may then select the “green machine” indicated via the application user interface, the machine may flash its lights to indicate “this one” and the user can then tap an indicator in the application to verify machine selection and electronically pair a user device with that machine. The user may then access or enter information for selected machines and share the information with other devices connected to the local fleet connectivity system through the application.

For example, in response to a user selection on an application hosted on the user device 308, one or more machines can be located and/or identified by one or both of a visual or audible signals from the selected machine or the connectivity module coupled to the machine. In some embodiments, the connectivity module 320 may include one or both of a light or sound generator and may be configured to identify a machine by generating one or both of a visual or audible signal (e.g., alerts, indications, etc.). For example, the connectivity module 320 may include a beacon 326 with a light (e.g., an RGB LED light) which is lit when a user presses a button on an application (e.g., an identify-my-machine application on a user device 308). Additionally or alternatively, the connectivity module 320 may be communicatively coupled to one or more lights (e.g., headlights, cabin lights, an incandescent light, a light emitting diode, a fixed beacon, a flashing beacon, a rotating beacon, a laser, a light array, etc.), display devices, or markers, etc. of the work machine 324 (e.g., via the control system 322) and can instruct the lights, devices, markers, etc. to generate the visible signals in response to the selection of a button on the user device 308. The beacon 326 may additionally or alternatively include a speaker to provide the audible signals. Additionally or alternatively, the connectivity module 320 may be communicatively coupled to a horn or speaker of the work machine 324 (e.g., via the control system 322) and can instruct the horn or speaker to generate the audible signal in response to the selection of a button on the user device 308

The local fleet connectivity system 300 may allow a user to identify multiple machines of a plurality of machines. Each machine may include a connectivity module 320 that is part of or physically coupled to the machine (e.g., machine 324). The connectivity module may be communicatively coupled to the control module 322 of the machine and may be configured to communicate with the other connectivity modules via a network connection. A user may use a user device (e.g., user device 308) configured to communicate with the one or more connectivity modules via a network connection. A user may make selections of machines using an application on the user device. In response to the selection, the selected devices can be identified by one or both of an audible signal or a visual signal. For example, if a user selects machines 304 and 324 via the user device 308, machines 304 and 324 may generate an audible or visual signal using their respective horns, headlights, or a machine visual indicator coupled to the respective connectivity unit. In some embodiments, each machine is identified by a different visual or audible signal. For example, if the connectivity modules of the two or more machines each comprise a light configured to illuminate to generate the visual signal, the light of each connectivity module of the two or more machines may illuminate with a different color.

In some embodiments, the user may make a selection of machines by dynamically filtering the plurality of machines according to one or more selectable attributes or criteria. The selectable attributes or criteria may include, for example, one or more of a machine type, a battery status, a machine model number, a machine manufacturer, a machine location, a machine worksite tag, a machine status, a repair status, a DTC status, a fuel status, a use status, or the number of other machines that must be used to access or move a machine. Upon receiving an indication of the selected attributes, the server may send a request to the various machines for each machine to transmit the attributes and values associated with each machine. In some embodiment, the user device displays a map showing the locations of the plurality of machines. Machines that do not match the filter criteria may be temporarily removed from the map. In some embodiments, if work machine 324 matches the filter criteria as selected by the user, beacon 326 may illuminate to indicate to the user that work machine 324 is available for use. In other embodiments, multiple work machines that match the filter criteria may indicate to the user their available status at the same time.

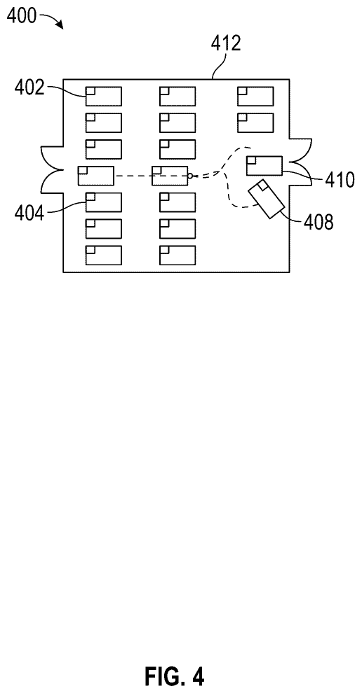

As described in further detail in FIG. 4, in some embodiments, the user may select a user-selected first machine and a location that the user-selected first machine is to be moved to. The application on the user device may automatically determine one or more other machines that are required to be moved in order to move user-selected first machine to the selected location. For example, if a user selects a scissor lift in a corner of a room, that cannot be moved to a desired location without moving a boom lift out of the way, the application may automatically select the boom lift and the both the scissor lift and boom lift may generate a visual or audible signal. In some embodiments, a control module of each of the automatically selected machines may be configured to receive instructions via the connectivity module of the associated machine and to control and move the associated machine out of a path of the user-selected first machine to the selected location. Thus, the machines may be configured to move automatically, based on instructions from the user device and or other computer systems connected to the local fleet connectivity system 300, to allow the user-selected first machine to move to the selected location. The machines may also communicate with each other through their respective connectivity modules to, e.g., avoid collisions between machines.

In some embodiments, the beacon 326 may function as a machine visual indicator. The beacon may provide a signal to an observer. The signal may indicate a state or condition of the machine (e.g., power on, power off, in operation, fuel level, electrical system state of charge, diagnostic trouble code (DTC) status, maintenance required). In other examples, the signal may indicate that a machine matches a search criteria of a renal customer. In other examples, the machine visual indicator may be a machine component or a separate device attached to the machine (e.g., a vehicle external light, a vehicle internal light, a beacon, etc.). The machine visual indicator may be a light (e.g., an incandescent light, a light emitting diode, a fixed beacon, a flashing beacon, a rotating beacon, a laser, a light array, etc.), a display device, a marker, etc. In some examples, an audible indicator of a machine state. In some embodiments, the machine state visual indicator may be placed above the work machine. In this embodiment, the machine visual indicator may be used for any machine positioned directly below the machine visual indicator. In this embodiment, a user may pair the machine visual indicator to the machine positioned directly below the light through the use of the user device by inputting a description of the machine in a field connected with the machine visual indicator (e.g., a serial number, a color of the machine, a VIN number, etc.). Alternatively, the connectivity module of the machine may be communicating with the machine visual indicator to automatically pair the machine with the machine visual indicator when the machine is positioned near the machine visual indicator. This may be accomplished through the use of RFID tags, BLE, a wireless mesh network, etc.

The machine visual indicator is configured to generate a variety of visual signals. In some examples, the variety of visual signals comprises one or more colors, patterns, and combinations of colors and patterns. In some examples, the machine visual indicator is configured to generate visual signals observable as a light or one or more light patterns. In some examples, the light patterns generated by the machine visual indicator can be varied in any optical characteristic (e.g., color, wavelength, intensity, pulse duration, direction, etc.).

Visual signals generated by the machine visual indicator show various states, conditions, and criteria of the machine. The visual signals may indicate, for example, one or more machines on a worksite that have sufficient fuel levels to perform a task. In other examples, the visual signals generated by the machine visual indicator illustrate predefined or user-configurable machine states for the local identification of that state. For example, a scissor lift machine 304 can flash a beacon light indicating that it requires a charge. In some embodiments, the visual signal may be initiated in response to a local user command entered by a user at a user device 308, a remote user command, a machine-to-machine command, a condition or state detected by a machine onboard sensor, a controller 322 logic determination, or an availability status as determined by a user-selected set of machine attribute criteria.

In some embodiments, machine onboard sensors detect a state or condition of the machine 324. The machine controller 322 determines a command to the connectivity module 320 or directly to the machine visual indicator to display one or more visual signals. In some embodiments, the machine visual indicator illuminates a colored light signal corresponding to a machine state or condition. For example, a worksite supervisor may select green to indicate a fuel level above ¾ of capacity, yellow to indicate a fuel level between ¾ and ¼, and red to indicate a fuel level below ¼. In another example, a service technician may transmit a wireless command to all machines on a worksite to flash a red light if the machine controller detects a battery charge below a user-specified level. In another example, an owner of a group of machines may select green to indicate to a customer that the machine matches the customer-selected requirements. Additionally, the owner of a group of machines may select red to indicate to the customer that the machine does not match any of the customer-selected requirements and yellow to indicate to the customer that the machine matches some of the customer-selected requirements. In some embodiments, the customer may select required attributes and optional attributes. In such an embodiment, green may indicate that the machine has the required attribute and yellow indicates that the machine has the optional attribute.

In some embodiments, a machine visual indicator application hosted on a user device 308 presents a user interface to a user. The application user interface receives user selections of a criterion for a machine state and a visual signal corresponding to the criterion. For example, a user selects state of charge as a criterion for electric-powered scissor lift machines 304 on a worksite or rental lot and one or more state visual indicator signals (e.g., a colored light) corresponding to one or more state of charge conditions. The user inputs are transmitted to machines 304, 324 via a network. User inputs received at the connectivity module 320 generate one or more commands to the machine visual state indicator. Each machine visual indicator for the machines at the worksite then responds to the user input by displaying a light beacon with a color representing a status of that machine for the selected criterion (e.g., machines with good charges show green lights, machines requiring a recharge show yellow lights, and machines requiring battery replacement show red lights.).

The machine visual indicator is configurable to function when the machine's power is off. For example, the machine visual indicator may receive user inputs via a Bluetooth low energy (BLE) signal received at the connectivity module 320. The BLE communications path can be configured to remain always active with power input from a machine power source (e.g., a battery). In some examples, the BLE communications channel in the connectivity module 320 remains open and the machine visual indicator is available to display a visual signal in response to a user input in a power-saving mode (e.g., modified receiver duty cycles, reduced communications/BLE intervals, lower power operation of the machine visual indicator beacon).

In some embodiments, the local fleet connectivity system 300 may support commercial services. In some embodiments, the local fleet connectivity system includes one or more applications hosted on one or more processors. Host processors may comprise a machine controller 322, a connectivity module controller, and a user device controller. In some examples, commercial services supported by the local fleet connectivity system 300 may comprise advertising, user-preference identification, point of sale, third-party messaging, etc. In some examples, an application hosted on one or more of a machine controller and a user device may generate user interfaces for commercial services. In some examples, the application may generate one or more of audio, visual, and tactile signals to convey messages associated with commercial services. In some examples, the application may be configured to display recommended purchases to the user based on the state or condition of the machine connected to the local fleet connectivity system or a parameter associated with a user of the equipment identity system. In some examples, the application may provide point-of-sale services (e.g., order entry, payment acceptance, order tracking, etc.).

Further referring to FIG. 3, in some embodiments, the local fleet connectivity system 300 may comprise electronic commerce functions. In some examples, electronic commerce functions are accessed through a tab or page within the application, a click-through popup within the application, a scrolling banner within the application, a push notification, etc. In some examples, the electronic commerce functions provided through the local fleet management system 300 may be managed by an electronic commerce application hosted on a controller installed in a machine 304, 324 or a user device 308. Electronic commerce functions provided through the local fleet connectivity system may comprise, for example, original equipment manufacturer advertising (e.g., service kits, equipment consumables, and replacement parts based on a status or condition of a machine). In some examples, electronic commerce messages are transmitted via the equipment identity system. Electronic commerce messages may comprise, for example, messages based on a specific machine or machines being accessed, a profile or a nature of a person accessing the specific machine or machines, weather or local conditions around the machine or machines, conditions or states associated with the machine (e.g., engine hours, fault codes, etc.), location of the machine, location of the worksite, proximity of a vendor to a worksite, etc. In some examples, the application is a point-of-sale portal for purchasing items or services identified in electronic commerce messages. For example, an original equipment manufacturer OEM) may determine a work machine component requires replacement based on the condition of the component as detected by a sensor on the work machine and reported to the OEM via the equipment identity system. The OEM may locate the nearest replacement part, determine a price and delivery time for the part, and generate a push message to a user on a user device at a worksite identifying the need to replace the component, the price and arrival time for the replacement component, a purchase incentive for ordering the component through the application, process the order through the user device, and provide post-sale services (e.g., delivery status, installation instructions, warranty support) through the application.

In some examples, the electronic commerce functions supported through the applications may include third-party advertising and point of sale. For example, the electronic commerce application may provide notifications to equipment users from a restaurant in proximity to a worksite based on one or more parameters collected by the application. Parameters collected by the application may comprise, for example, a number of users present at a worksite, a time of day, a purchase incentive from a vendor, user preferences, etc. The application may, for example, capture a record of sales conversions in response to application electronic commerce messaging as a basis for revenue calculation for a sales channel supported by the electronic commerce functions enabled by the local fleet connectivity system 300.

Further referring to FIG. 3, in some embodiments, the machine controller 322 is configured to receive data from a first pressure sensor on the machine. The machine controller 322 determines a vertical location component for a machine position. In some examples, the machine controller 322 is configured to determine the position of the machine 324 with respect to a floorplan of a worksite (e.g., the position of the machine is identified with a floor of a structure in which the machine is located). In some examples, the machine controller 322 determines the position of a machine on a network (e.g., a mesh network) with respect to a mobile user device 308 or another machine 304. In some examples, the machine controller 322 receives pressure sensor data from a second sensor at a load (platform/forks/etc.) relative pressure difference between chassis and can be used for elevation verification or calculation as well.

Further referring to FIG. 3, in some embodiments, a controller 322 is configured to determine a relative height differential between a first pressure sensor and a second pressure sensor. The first pressure sensor measures a first pressure measurement at a first location and the second pressure sensor measures a second pressure at a second location. In some examples, the first pressure sensor is provided on a first machine 324 and communicatively connected to the controller 322. In some examples, the second pressure sensor is an off-board (i.e. not located on the first machine) sensor. The second pressure sensors may be provided, for example, on a user device 308 (e.g., a phone), a second machine 304, a load, an implement, a worksite hub device, etc. In some examples, the second pressure measurement at the second pressure sensor may be transmitted to the controller 322 of the first machine 324 via a direct local connection (e.g., a BLE connection, a Wi-Fi connection, etc.). In some examples, the second pressure measurement is transmitted by the second sensor to the controller 322 via a network connection. In some examples, the controller 322 may determine the local relative height differential between the first pressure and the second pressure sensor. The controller may, for example, transmit the relative local height differential to other machines connected to a local network via the connectivity module. In some examples, the relative pressure difference between a first pressure sensor attached to a chassis of the machine and a second pressure sensor attached to an implement or located at a load (e.g., a platform, a set of forks of a forklift, etc.) may transmit a first pressure measurement and a second pressure measurement to the controller 322. In some examples, the controller 322 may use the first pressure measurement and the second pressure measurement to calculate or verify a height of the implement or the load. The controller may, for example, use the calculated or verified height of the implement or the load as a safety check within a height safety application supported by the worksite network.

In some examples, a machine 324 may be configured with a first pressure sensor on the base of the machine and a second pressure sensor on the platform of the machine. The controller 322 may receive a first pressure measurement from the first pressure sensor and a second pressure measurement from the second sensor. The controller 322 may dynamically determine an operational height of the platform of the machine based on the difference between the first pressure measurement and the second pressure measurement. The operational height of the platform may be transmitted, for example, to other machines 304 connected to the local network 312, to a remote processor 306 via a network connection, or to a worksite hub device. In some examples, the operational height of the platform may be provided for external consumption by other devices connected to the network or used as part of the machine's 324 local controls.

The local fleet connectivity system 300 further allows for the coordination of multiple machines 304, 324 within the same worksite, or a fleet-wide control. For example, if a first work machine 324 is required to accomplish a task collaboratively with a second work machine 304, a user interacting with a user device 308 may provide commands to the first work machine 324 and second work machine 304 to execute the task in collaboration.

As shown in FIG. 4, the local fleet connectivity system 400 may be deployed at a worksite 412 to control a fleet of work machines 402, 404, 408, 410 via a connectivity module to collaboratively perform tasks requiring more than one work machine 408, 410. For example, a user may wish to move the work machine 410 from its stored position on the left of the worksite 412 out the door on the right of the worksite. The connectivity module may communicate with both the work machine 408 and the work machine 410, causing the work machine 408 to move out of the way of the work machine 410, so that the work machine 410 can move past the work machine 408 and out the doorway.

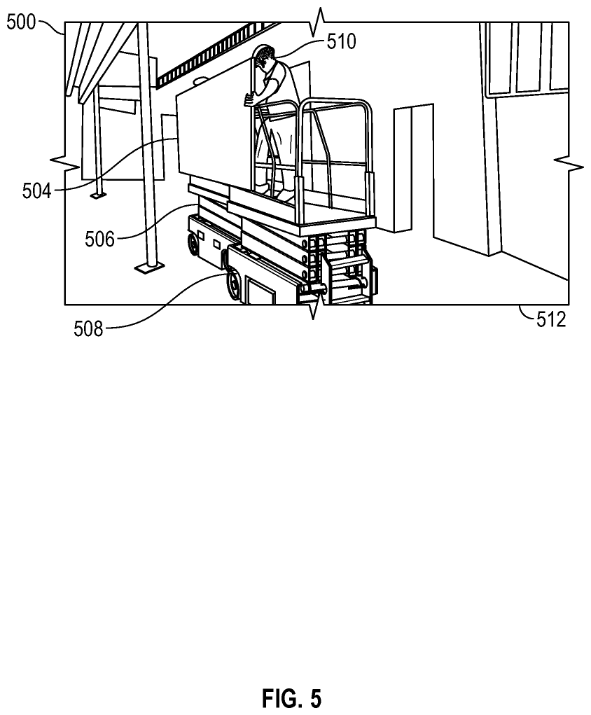

As shown in FIG. 5, a plurality of work machines 506, 508 connected to local fleet connectivity system 500 may collaboratively perform tasks on a jobsite 512 requiring more than one work machine, for example placing a section of drywall 504 that is too large to be handled by a single work machine. A user device may communicate with both the work machine 506 and the work machine 508 and cause them to move at the same speed and in the same direction so that a user 510 on each machine 506, 508 can hold the drywall 504 while the machines 508, 506 are moving. Connectivity between the machines 508, 508 and with the local fleet connectivity system 500 can prevent the machines 508, 506 from being separated so that the users 510 do not drop the drywall 504.

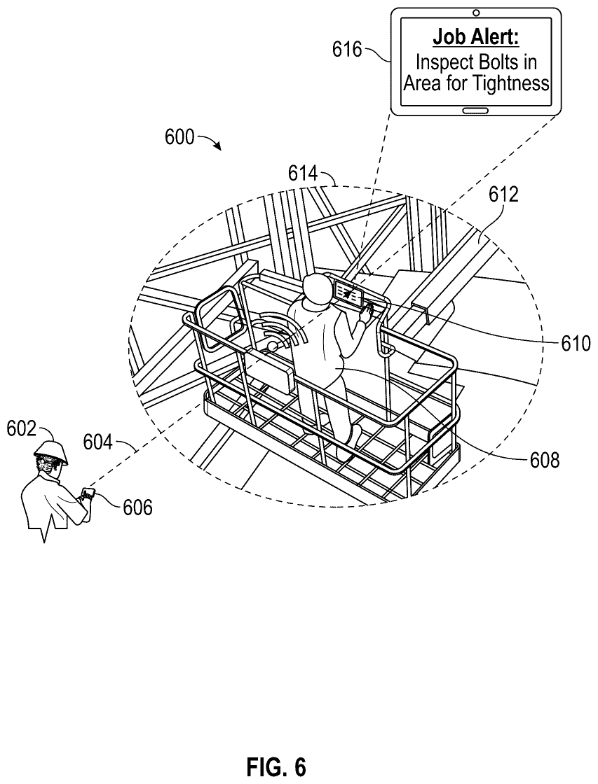

As shown in FIG. 6, a remote user 602 of a local fleet connectivity system 600 can send messages and data 604 from a remote device 606 to an onsite user 608 on a jobsite 614. The messages and data 604 may be received by the control system 610 of a work machine 612 and displayed via a user interface on an onboard display 616. The remote user 608 may send work instructions to the onsite user 608, informing the onsite user 608 of tasks to be performed using the work machine 612. For example, as shown in FIG. 6, the remote user 602 may send instructions to the onsite user 608 to use the work machine 612 to inspect bolt tightness in the area. The instructions may displayed for the onsite user 608 on the onboard display 616. This allows the onsite user 608 to receive and view the instructions without the need to call the remote user 602 or write the instructions down. Because the work machine 612 is connected to the remote device 606 (e.g., via a connectivity module 218) the remote user 602 may receive the location of the work machine 612, as well as other work machines on the jobsite 614, and may use the location information to determine the instructions to send. In other embodiments, an available status may be displayed on the onboard display 616 to indicate to a customer that the work machine 612 is available for rent. In other embodiments, the onboard display 616 may display to a customer the desired rental criterion and the work machine's 612 matching of the criteria.

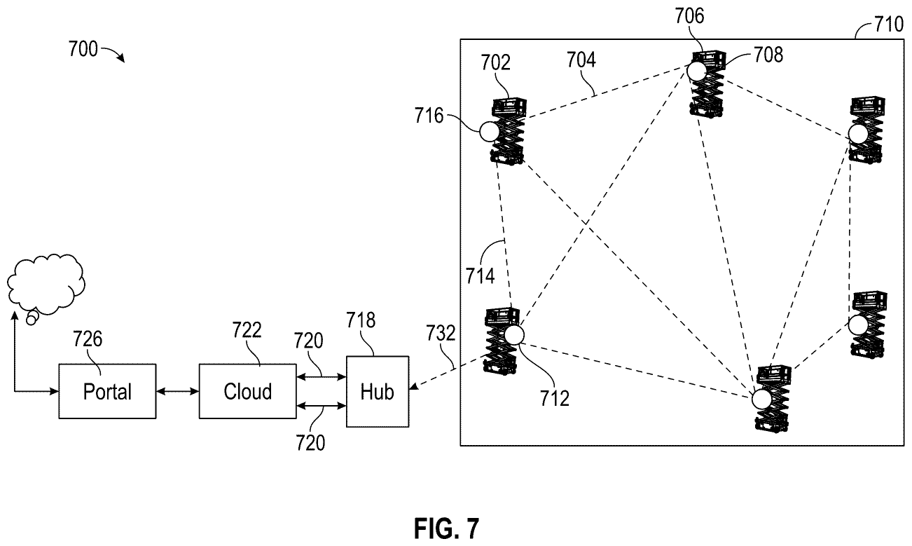

Referring to FIG. 7, a local fleet connectivity network system 700 includes a connectivity hub 718. In some embodiments, the connectivity hub includes a connectivity module. In some embodiments, the connectivity hub is configured to communicatively connect with one or more connectivity module equipped machines 702, 706 in proximity to the connectivity hub 718. In some embodiments, the connectivity hub is configured to broadcast a worksite identification signal. In some embodiments, the connectivity hub is configured to connect worksite machines 702, 706 connected to the local fleet network to an external internet feed 720. In some configurations, the connectivity hub is configured as a gateway to one or more communications systems or network systems to enable exchanges of data 720, 722 between nodes 708, 712, 716 on the worksite 710 local fleet connectivity mesh network 704, 714, 732 and nodes 726 external to the worksite.

In some embodiments, the connectivity hub has a connectivity module that (a) provides the functionalities described here in place of or in addition to a machine that has a connectivity module, (b) broadcasts a site identifier, or (c) connects to an external internet to flow through data to and from the jobsite that is provided across the mesh.

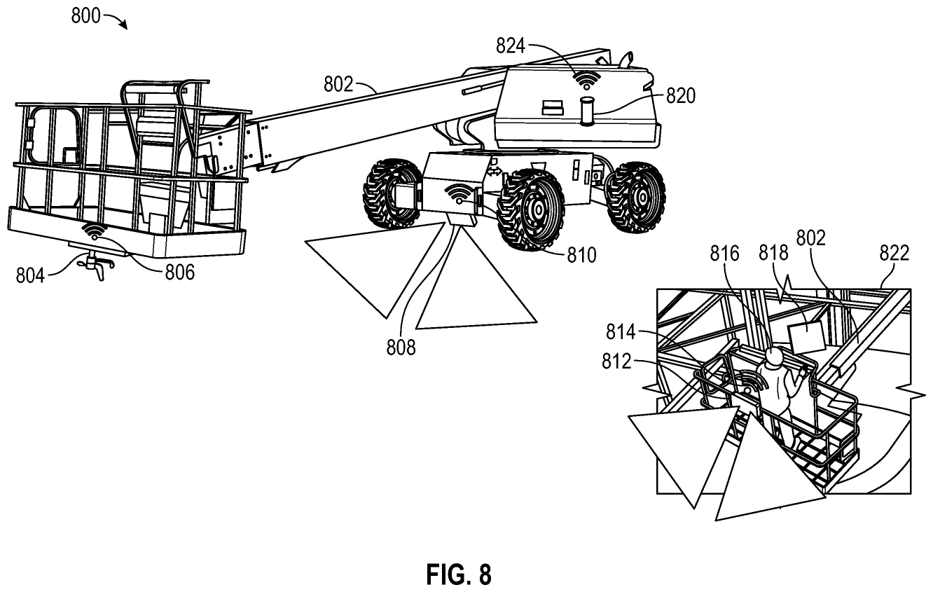

Referring to FIG. 8, a sensor network system 800 is shown. Sensors 804, 808, 812, 820 may be coupled to a work machine 802 on a jobsite 822. The sensors may be, for example, object detection sensors 808, 812, environmental sensors 804 (e.g., wind speed, and temperature sensors), and tagged consumable sensors 820. The sensors 804, 808, 812, 820 may be connected to and may send data to a local fleet connectivity system via wireless connections 806, 810, 814, 824. The sensor data may be displayed or may be used to generate messages for display on an onboard display 818 for a user 816 of the work machine 802. The onboard display 818 may receive the sensor data via a direct wired or wireless connection to the sensors. Alternatively, the sensors may communicate with the onboard display through the local fleet connectivity system (e.g., via a connectivity module 218). Sensor data from various work machines may be combined to map the jobsite 822 and to determine if environmental conditions are safe for using the work machines. Sensor data from the tagged consumable sensors 820 may be used to determine, for example, when tagged consumables must be replaced.

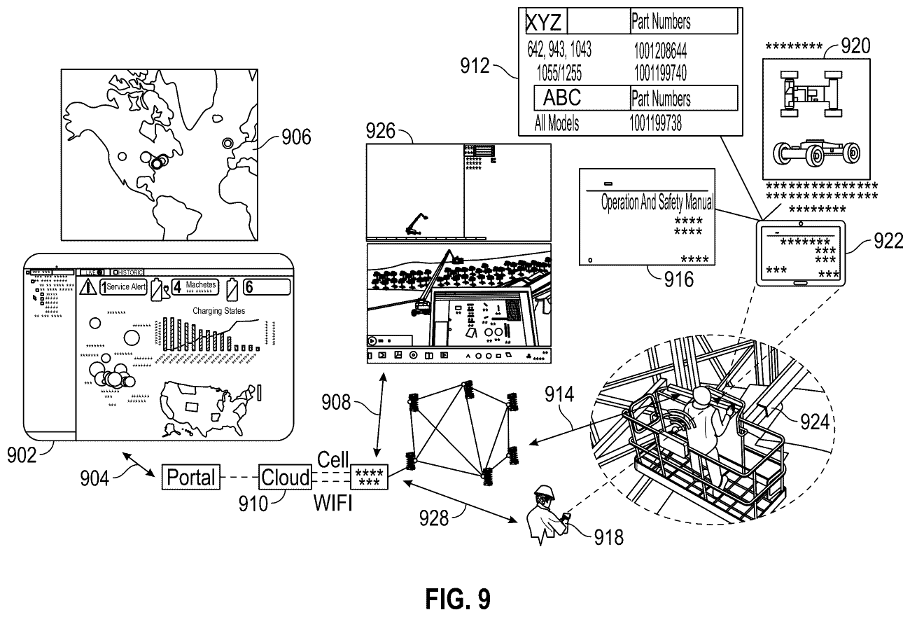

As shown in FIG. 9, various user interfaces are available to be displayed on a remote user device 918 and an onboard display 922 of a work machine 924. A connectivity hub 910 may send and receive data 928, 908, 904, 914 including the user interfaces 902, 906, 912, 916, 926, 920. The user interface 906 is a heatmap of locations of a plurality of work machines. The user interface 902 is a machine status display that shows the battery level, location, and alerts relating to a plurality of work machines. User interface 926 shows a digital twin of a work machine that updates based on sensor data of an associated work machine. User interface 912 is a list of part numbers for the work machine 924. User interface 916 is an operation and safety manual for the work machine 924. User interface 920 is a detailed schematic of the work machine 924.

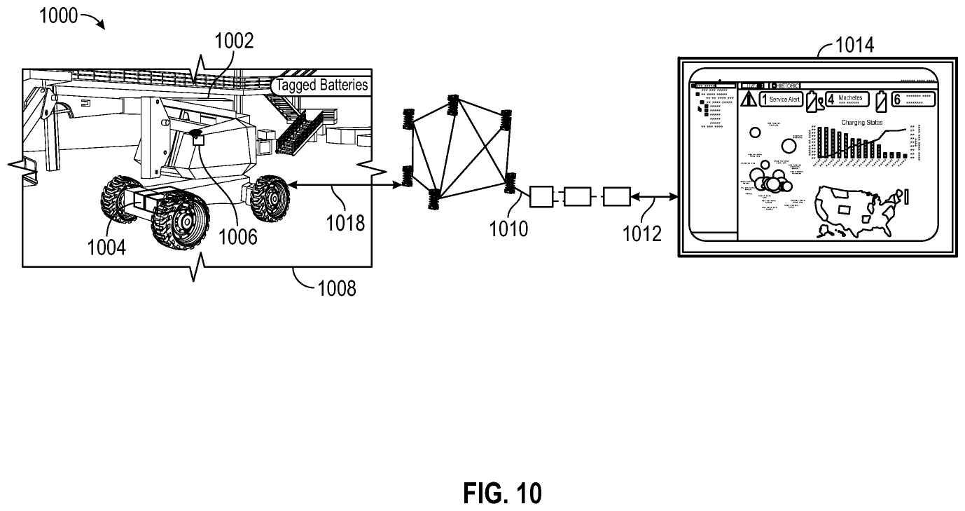

As shown in FIG. 10, a tagged consumable tracking system 1000 is shown. A work machine 1002 on a jobsite 1008 includes tagged consumables 1004 (e.g., batteries connected to battery charger 1006). The machine 1002 sends and receives data 1018 to and from the connectivity hub 1010. The connectivity hub 1010 sends and receives data 1012 to and from a user interface 1014. Data regarding the tagged consumables 1004 may be communicated to the user interface 1014 via the connectivity hub 1010. For example, battery charge state and battery health may be sent to the user interface 1014. When the battery health falls below a predetermined state, for example, when the battery is only able to hold half of its original charge, the connectivity hub 1010 may send an alert to the user interface 1014 indicating that the battery should be replaced.

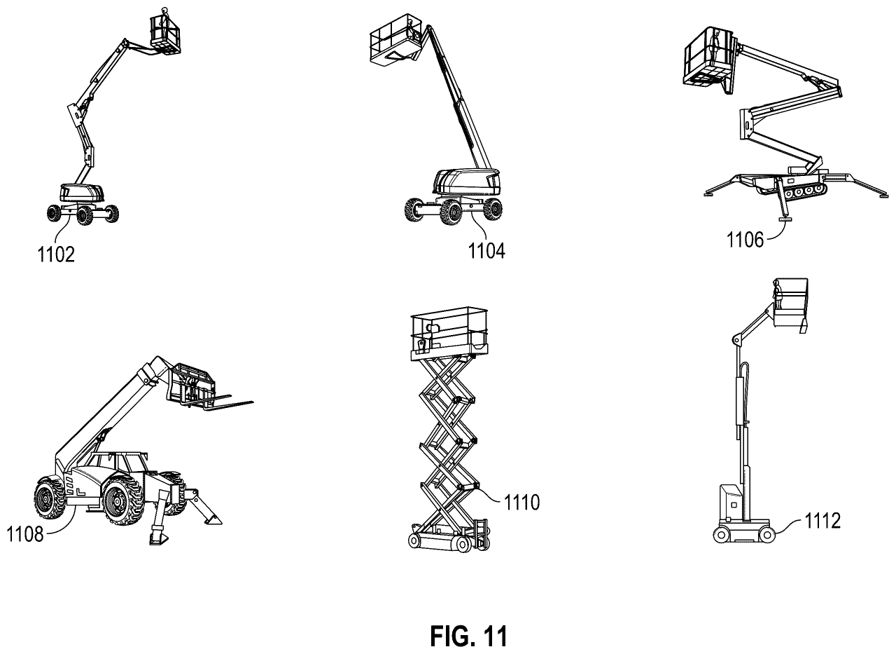

FIG. 11 shows various embodiments of a work machines 20 (e.g., lift devices including articulating boom lift 1102, telescoping boom lift 1104, compact crawler boom list 1106, telehandler 1108, scissor lift 1110, toucan mast boom lift 1112). As an example, telescoping boom lift 1104 includes a chassis (e.g., a lift base), which supports a rotatable structure (e.g., a turntable, etc.) and a boom assembly (e.g., a boom). According to an exemplary embodiment, the turntable is rotatable relative to the lift base. According to an exemplary embodiment, the turntable includes a counterweight positioned at a rear of the turntable. In other embodiments, the counterweight is otherwise positioned, and/or at least a portion of the weight thereof is otherwise distributed throughout the work machines 20 (e.g., on the lift base, on a portion of the boom, etc.). As shown in FIG. 11, a first end (e.g., front end) of the lift base is supported by a first plurality of tractive elements (e.g., wheels, etc.), and an opposing second end (e.g., rear end) of the lift base is supported by a second plurality of tractive elements (e.g., wheels). The front tractive elements and the rear tractive elements include wheels of telescoping boom lift 1104; however, in other embodiments, the tractive elements include a track element.

As shown in FIG. 11, the boom of telescoping boom lift 1104 includes a first boom section (e.g., lower boom, etc.) and a second boom section (e.g., upper boom, etc.). In other embodiments, the boom includes a different number and/or arrangement of boom sections (e.g., one, three, etc.). According to an exemplary embodiment (e.g., articulating boom lift 1102), the boom is an articulating boom assembly. In one embodiment, the upper boom is shorter in length than the lower boom. In other embodiments, the upper boom is longer in length than the lower boom. According to another exemplary embodiment, the boom is a telescopic, articulating boom assembly. By way of example, the upper boom and/or the lower boom may include a plurality of telescoping boom sections that are configured to extend and retract along a longitudinal centerline thereof to selectively increase and decrease a length of the boom.

As shown in FIG. 11, the lower boom of telescoping boom lift 1104 has a first end (e.g., base end, etc.) and an opposing second end (e.g., intermediate end). According to an exemplary embodiment, the base end of the lower boom is pivotally coupled (e.g., pinned, etc.) to the turntable at a joint (e.g., lower boom pivot, etc.). The boom includes a first actuator (e.g., pneumatic cylinder, electric actuator, hydraulic cylinder, etc.), which has a first end coupled to the turntable and an opposing second end coupled to the lower boom. According to an exemplary embodiment, the first actuator is positioned to raise and lower the lower boom relative to the turntable about the lower boom pivot.

As shown in FIG. 11, the upper boom of telescoping boom lift 1104 has a first end (e.g., intermediate end, etc.), and an opposing second end (e.g., implement end, etc.). According to an exemplary embodiment, the intermediate end of the upper boom is pivotally coupled (e.g., pinned, etc.) to the intermediate end of the lower boom at a joint (e.g., upper boom pivot, etc.). As shown in FIG. 11, the boom of telescoping boom lift 1104 includes an implement (e.g., platform assembly) coupled to the implement end of the upper boom with an extension arm (e.g., jib arm, etc.). In some embodiments, the jib arm is configured to facilitate pivoting the platform assembly about a lateral axis (e.g., pivoting the platform assembly up and down, etc.). In some embodiments, the jib arm is configured to facilitate pivoting the platform assembly about a vertical axis (e.g., pivot the platform assembly left and right, etc.). In some embodiments, the jib arm is configured to facilitate extending and retracting the platform assembly relative to the implement end of the upper boom. The boom includes a second actuator (e.g., pneumatic cylinder, electric actuator, hydraulic cylinder, etc.). According to an exemplary embodiment, the second actuator is positioned to actuate (e.g., lift, rotate, elevate, etc.) the upper boom and the platform assembly relative to the lower boom about the upper boom pivot.

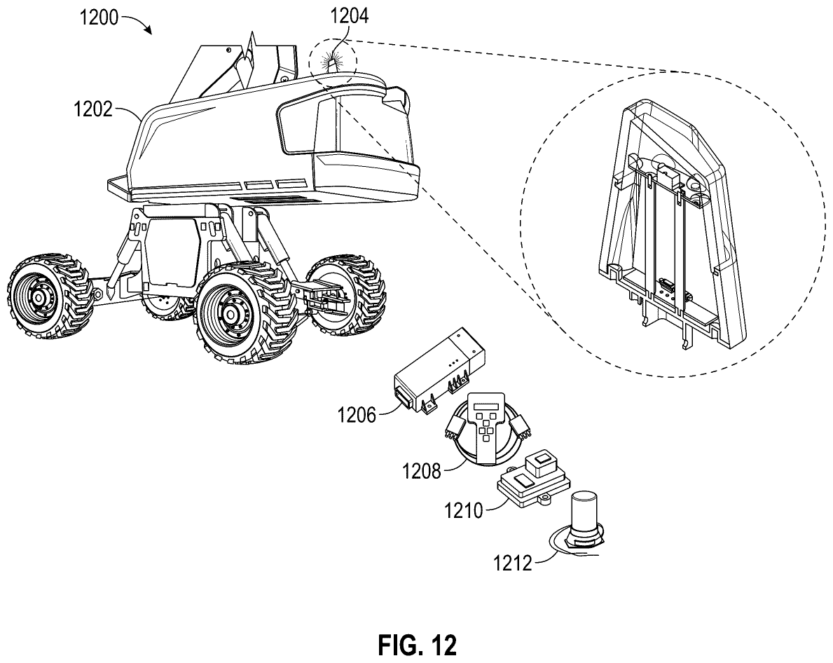

Referring to FIG. 12, a work machine 1202 is provisioned with an indicator 1204 (e.g., a connectivity module with an integrated beacon light, control devices, and communications devices). The indicator 1204 may, for example, illuminate a light visible to a user in response to user activation of a “find my machine,” “identify my equipment,” or “rental” application hosted on a user device connected to the equipment identification system 200. The indicator 1204 may function like a conventional work machine warning beacon 1212.

In some embodiments, the connectivity module may be configured with a telematics control unit 1206, a multi-function light beacon 1212, one or more multi-channel communication modems 1210, one or more analytics devices 1208, one or more antennas, one or more power sources, one or more positioning systems, one or more local fleet connectivity processors, and one or more interface blocks, one or more machine connectivity provisions, and one or more memory devices. For example, the connectivity module with integrated beacon 1204 may be configured as an integrated connectivity device provisioned with all components required to connect a work machine 1202 that is not provisioned with networking equipment to an equipment identification system 200. The connectivity module with integrated beacon 1204 may include, for example, a telematics control unit-specific componentry included (e.g., multi-color beacon, GPS/GNSS, communications modem, antenna, controller, memory device, interface blocks, housing, etc.) and be affixable to a work machine using temporary or permanent physical, electrical, or electronic connections. The connectivity module connected to the work machine may be configured to selectively enable, activate, disable, and deactivate components of the connectivity module and the work machine to which it is communicatively connected. For example, a connectivity module with integrated beacon 1204 connected to a work machine equipped with headlights may enable and activate the work machine headlights and disable the integral beacon in response to a “find me” command received by the connectivity module from the equipment identification system 200. The connectivity module with integrated beacon 1204 is configured, in some embodiments, to determine what components integral to the module and what components that are machine equipment are activated in response to a command such that only the components necessary to respond to the command are activated and no individual components are activated in conflict with the components activated to respond to the command.

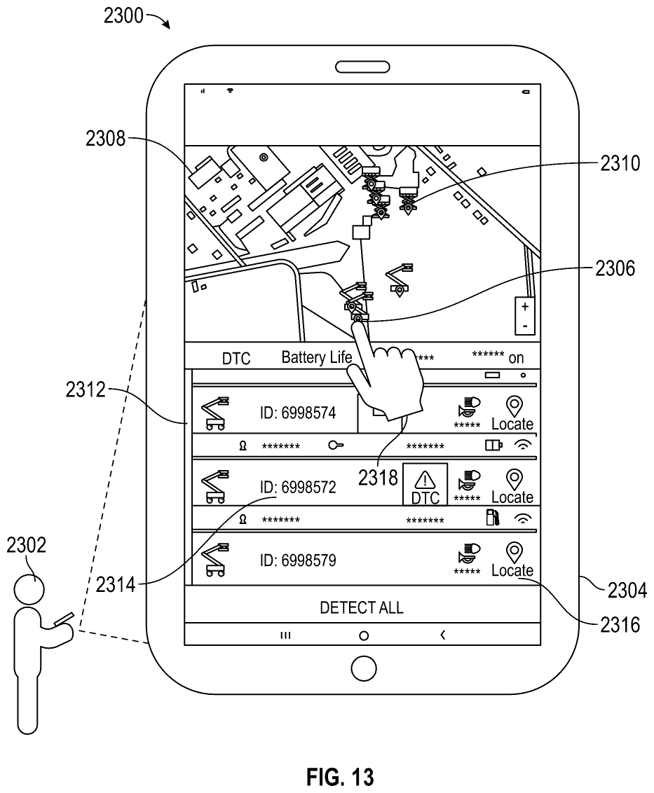

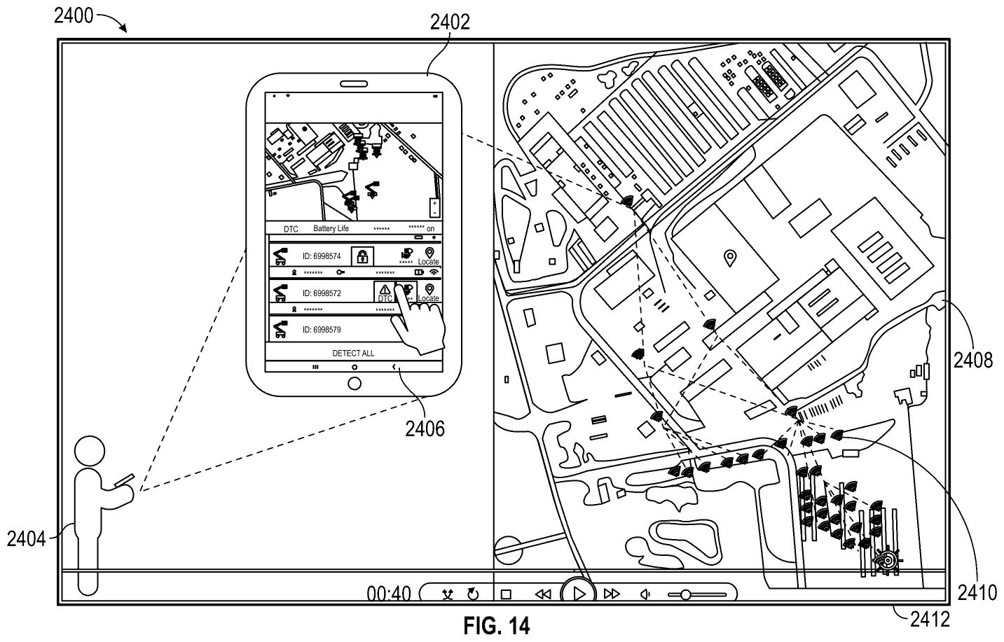

Referring to FIG. 13-14, a user 2302 may use the local fleet connectivity system by interacting 2318 with an application hosted on a user device 2304 that generates a user interface 2308. The user device 2304 and various work machines 1202 are interconnected via the local fleet connectivity system 200. The user 2302 selects a machine 2306 from a view of a group of machines 2310 connected to the local fleet connectivity system 200 at a worksite. The user interface 2308 may depict, for example, imagery of a worksite or rental lot with overlays of machine locations (e.g., a map) 2310 and information regarding machine-specific information including status (e.g., location, fuel state, state of charge, etc.) 2312, 2314, 2316. The application may dynamically filter the map to illustrate the total machine population and locations and statuses of individual machines in the population. In some examples, a remote user may apply filters (e.g., proximity to a user, filters related to machine status including self-test, fuel level, state of charge, etc.) to a specific worksite or rental network much the same as can be done locally via an application on a mobile user device (e.g., in the instance where a remote user can apply the desired user configurable rules to assist a local user without the need of mobile application use). The user may select a machine or group of machines using an application and communicate with the machine or group of machines (directly or via a cloud) to have that machine provide an equipment identification indication (e.g., a colored light, a light pattern, a combination of light colors and patterns, activation of a horn). Alternatively, the local user may select a set of criteria for which the user is looking for. In response to the user's selected criteria, all the machines matching the user-selected criteria may indicate through an equipment identification indication (e.g., a colored light, a light pattern, a combination of light colors and patterns, activation of a horn) that the machines match the criteria.

In some embodiments, user 2302 may represent a rental customer from desiring a rental machine. The user may interact with the user device 2304 to select a set of criteria that the user 2302 requires from a rental machine. These criteria may include various status states 2312, 2314, 2316 (e.g., location, fuel state, state of charge, machine reach, machine age, machine operating hours, etc.). The local fleet connectivity system may query the group of work machines 2310 to determine which work machines within the group of work machines 2310 match the user-selected criteria. Upon determining which work machines within the group of work machines 2310 match the user-selected criteria, a command may be sent to the work machine connectivity module to instruct the control module to illuminate a light or beacon associated with the work machine, or otherwise indicate to the user a matching status of the work machine.

Referring to FIG. 14, a user interface 2400 of a machine connectivity application is shown, according to an exemplary embodiment. The user interface 2400 may include a map 2408. The map may be an aerial view of a job site or a rental lot. The map 2408 may include machine indicators 2410 that show where machines are disposed on the map 2408. A light on a connectivity module can be used to identify a first machine 2412 of the plurality of machines within the job site and indicate various statuses of the first machine (e.g., fuel level, state of charge, fault status, ignition on/off, in operation, etc.). The application user interface 2406 on user device 2402 can be used by a user 2404 to select which status they want to be displayed on a fleet within user-defined parameters (e.g., a connected range of the user device). Features of the “find me” application can be used independently of or in conjunction with the filter criteria of a desired subset of a fleet. The equipment identification system application can also provide user interfaces for other instructions or commands (e.g., allowing a machine to be powered up or shut down).

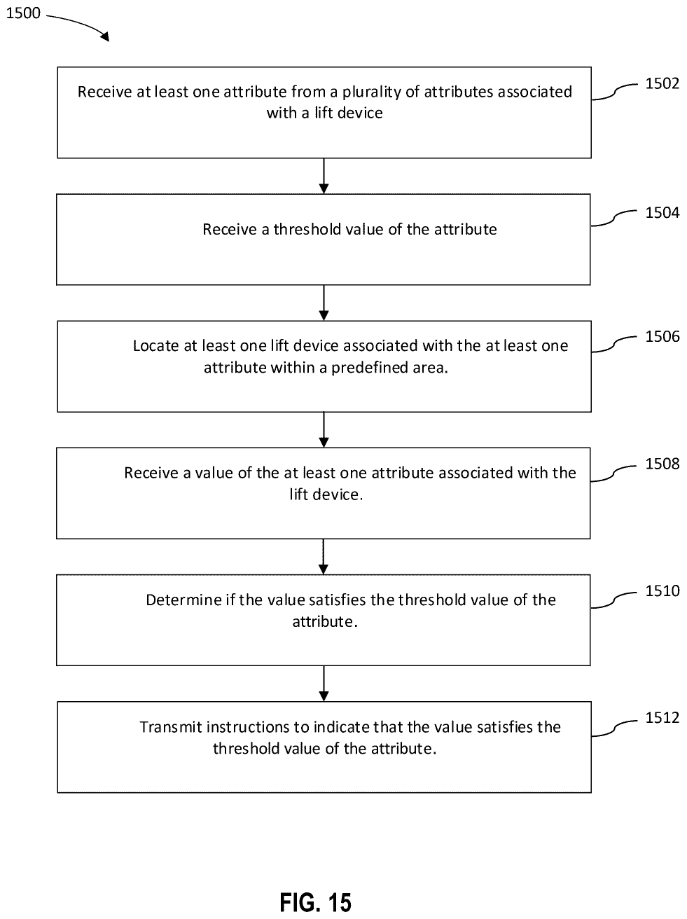

Referring to FIG. 15, a process 1500 (or method) for identifying machines meeting a customer's criteria requirements is shown according to some embodiments. The method may be performed by one or more processing circuits comprising one or more memory devices coupled to one or more processors. The one or more memory devices may be configured to store instructions thereon that, when executed by the one or more processors, cause the one or more processors to perform the operations of the method. In some embodiments, the one or more processing circuits may be integrated into a remote computing system (e.g., cloud and web services 268). In other embodiments, the one or more processing circuits may be integrated into a user device (e.g., user device 272). One or more machines may connect to the user device via a local wireless connectivity system or via a cellular network (e.g., via cell towers 240), or other existing or new means of digital connectivity. Each machine may include a connectivity module for communicating with the equipment identification system (e.g., connectivity modules 218, 320). The one or more processing circuits may communicate across a wireless network by sending messages to the one or more machines and to one or more electronic devices each communicatively connected to the network. A user may interact with the machines via an application provided on the electronic device that displays a graphical user interface (GUI).

At step 1502, an attribute from a plurality of attributes is received, according to some embodiments. In one embodiment, a customer of a rental lot of lift machines may utilize an electronic device to select one or more attributes required for a rental lift machine. The electronic device may be any suitable electronic device, such as a customer's cellular device, a customer's computer, a rental owner's computer, etc. In some embodiments the electronic device executes an application associated with the rental lot (i.e., a rental application), in other embodiments, the electronic device is connected by the internet (wired or wirelessly) to a server hosting a webpage associated with the rental lot. In these embodiments, the electronic device displays to the user a set of selectable attributes from which to choose. The selectable attributes may include lift machine attributes such as charging status, a charge level, a fuel level, a trouble code, a machine type, a machine reach, a machine age, machine operating hours, a price to rent, etc. The customer may choose the attribute desired through interacting with the electronic device, whether by text input, selecting a radio button, selecting from a dropdown menu, etc. The electronic device may display available attributes based on lift machines available to the customer at the rental lot. For example, all lift machines connected to a local mesh network located at the rental lot may be available to the customer. In such an embodiment, the rental application being run on the electronic device may display only attributes associated with the lift machines available to the customer in the rental lot. In some embodiments, the user may expand the search to nearby rental lots to view additional attributes to choose from.

At step 1504, a threshold value for the attribute is received, according to some embodiments. After the customer selects the desired attribute or attributes, the customer may choose desired threshold values for those attributes. For example, the customer may input into the electronic device a desired charge amount (e.g., over 75%), a desired machine reach (e.g., minimum 25 feet), a desired machine age (e.g., under 5 years old), etc. In some embodiments, the customer may choose several attributes and corresponding threshold values. In some embodiments, the customer only selects a single attribute and corresponding threshold value. In some embodiments, the customer may select a range of threshold values while in other embodiments the customer may choose a specific threshold value required. In some embodiments, only threshold values available within the rental lot are displayed to the customer. For example, all lift machines connected to a local mesh network located at the rental lot may be available to the customer. In such an embodiment, the rental application being run on the electronic device may display only values available that are associated with the lift machines available to the customer in the rental lot. In some embodiments, the user may expand the search to nearby rental lots to view additional attributes to choose from. For example, if a rental lot only has lift machines with a maximum reach of 25 feet, the customer would only be presented threshold values up to 25 feet. If the customer required a maximum reach above 25 feet, the customer could expand the search to nearby rental lots to find lift machines with a higher reach.

At step 1506, at least one lift device having the attribute is located within a predefined area, according to some embodiments. In one embodiment, once the customer has selected the attribute and associated threshold value, all the lift machines connected to a local mesh network are queried to find all available lift machines that have the attribute. In other examples, RFID tags may be used to determine machines in a predefined area. For example, if the required attribute is an electric charge value, all lift machines with an electric battery with a charge value are located. This locating step may occur in a variety of embodiments. For example, all available lift machines may be queried for a charge value, those returning a charge value are then located. In other embodiments, the electronic device queries a database of all available lift machines to locate all lift machines with a charge value.

At step 1508, a value of the attribute is received, wherein the value is associated with the at least one lift device, according to some embodiments. Once all lift machines with the attribute are located, a value with the associated attribute is received for each lift machine. This may occur through querying each machine through the connectivity module. In such an embodiment, the lift machine may return a value for the attribute. In other embodiments, a database containing attributes and associated values of the available lift machines is queried.

At step 1510, it is determined whether the value satisfies the threshold value, according to some embodiments. Upon receiving the values associated with the attribute for all available lift machines, the rental application determines whether the values satisfy the threshold value. For example, a lift machine with a maximum reach of 10 feet would not satisfy a customer-selected threshold value of 25 feet for the maximum reach attribute. Additionally, if the threshold value was selected to be a maximum reach of over 25 feet, the rental application would determine that all lift machines with a reach higher than 25 feet would satisfy the threshold value.

At step 1512, upon determining that the value satisfies the threshold value, an instruction to indicate that the value satisfies the threshold value is transmitted to notify a user that the value satisfies the threshold value, according to some embodiments. In an exemplary embodiment, the instruction is an instruction to illuminate a lighting apparatus associated with the lift machine. In some embodiments, the lighting apparatus is attached to the lift machine physically, electrically, or electronically. In some embodiments, the owner of the lift machine or rental lot may set a predetermined color for the lighting apparatus to display when the machine lift matches the customer's search criteria. In some embodiments, all the lift machines that do not match the customer's search criteria indicate, through illuminating a lighting apparatus, that the lift machine does not match the customer's search criteria. In one example, all lift machines matching the criteria illuminate a lighting apparatus green while all the lift machines not satisfying the search criteria illuminate a lighting apparatus red. In other embodiments, the lighting apparatus modifies other lighting characteristics to indicate to the customer that the lift machine satisfies the search criteria. For example, color, wavelength, intensity, pulse duration, direction, etc., are modified to draw the customer's attention to the lift machine.

In other embodiments, the lighting apparatus is associated with a spot in which the lift machine is located. In such an embodiment, the lighting apparatus is associated with the lift machine that is currently in the associated spot. In this way, a lighting apparatus may be used for any lift machine in the spot associated with the lighting apparatus.

In other embodiments, the instruction to indicate that the value satisfies the threshold value is an instruction to cause an aural indication. In such embodiments, the lift machine may honk a horn, play a sound, or otherwise create a noise that would indicate to the customer that the lift machine satisfies the threshold value.

In other embodiments, the instruction is an instruction to the electronic device. In such embodiments, the instruction is to highlight a lift machine within a list of available lift machines. In some embodiments, the electronic device may filter out of the list of available lift machines all lift machines that do not satisfy the search criteria. In such embodiments, the customer is presented on the electronic device with only the lift machines that match or otherwise satisfy the threshold value of the search criteria. In some embodiments, the customer may select on the electronic device one of the lift machines that satisfies the search criteria. In some embodiments, upon the customer selecting a single lift machine, the lighting apparatus associated with the selected lift machine may modify a lighting pattern. For example, upon selection of the lift machine, the lighting apparatus associated with the selected lift machine may be modified from a solid green light to a pulsing or blinking green light to indicate to the customer the selected lift machine.

Although the systems and methods are described herein with reference to a lift device, a lift assembly, or a work machine, the systems and methods may additionally or alternatively be applied to any other type of vehicle or machine. By way of example, these systems and methods may apply to any type of lift device (e.g., boom lifts, scissor lifts, vertical lifts, manual lifts, aerial work platforms, telehandlers, etc.). By way of another example, these systems and methods may apply to vocational vehicles, such as fire fighting vehicles, fire trucks, concrete mixers, delivery vehicles, military vehicles, refuse vehicles, etc.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

While various circuits with particular functionality are shown in FIGS. 1-3, it should be understood that the controller 44 may include any number of circuits for completing the functions described herein. For example, the activities and functionalities of the control system 60 may be combined in multiple circuits or as a single circuit. Additional circuits with additional functionality may also be included. Further, the controller 44 may further control other activity beyond the scope of the present disclosure.

As mentioned above and in one configuration, the “circuits” of the control system 60 may be implemented in non-transitory machine-readable medium for execution by various types of processors, such as the processor 52 of FIG. 1. An identified circuit of executable code may, for instance, comprise one or more physical or logical blocks of computer instructions, which may, for instance, be organized as an object, procedure, or function. Nevertheless, the executables of an identified circuit need not be physically located together but may comprise disparate instructions stored in different locations which, when joined logically together, comprise the circuit and achieve the stated purpose for the circuit. Indeed, a circuit of computer-readable program code may be a single instruction, or many instructions, and may even be distributed over several different code segments, among different programs, and across several memory devices. Similarly, operational data may be identified and illustrated herein within circuits and may be embodied in any suitable form and organized within any suitable type of data structure. The operational data may be collected as a single data set or may be distributed over different locations including over different storage devices, and may exist, at least partially, merely as electronic signals on a system or network.

While the term “processor” is briefly defined above, the terms “processor” and “processing circuit” are meant to be broadly interpreted. In this regard and as mentioned above, the “processor” may be implemented as one or more general-purpose processors, application-specific integrated circuits (ASICs), field programmable gate arrays (FPGAs), digital signal processors (DSPs), or other suitable electronic data processing components structured to execute instructions provided by memory. The one or more processors may take the form of a single-core processor, multi-core processor (e.g., a dual-core processor, triple-core processor, quad-core processor, etc.), microprocessor, etc. In some embodiments, the one or more processors may be external to the apparatus, for example the one or more processors may be a remote processor (e.g., a cloud-based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud-based server). To that end, a “circuit” as described herein may include components that are distributed across one or more locations.

Embodiments within the scope of the present disclosure include program products comprising machine-readable media for carrying or having machine-executable instructions or data structures stored thereon. Such machine-readable media can be any available media that can be accessed by a general-purpose or special-purpose computer or other machine with a processor. By way of example, such machine-readable media can comprise RAM, ROM, EPROM, EEPROM, or other optical disk storage, magnetic disk storage or other magnetic storage devices, or any other medium that can be used to carry or store desired program code in the form of machine-executable instructions or data structures and which can be accessed by a general purpose or special purpose computer or another machine with a processor. Combinations of the above are also included within the scope of machine-readable media. Machine-executable instructions include, for example, instructions and data that cause a general-purpose computer, special-purpose computer, or special-purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

Although this description may discuss a specific order of method steps, the order of the steps may differ from what is outlined. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps, and decision steps.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from the scope of the present disclosure or from the spirit of the appended claims.

What is claimed is:

1. A computer-implemented method of identifying a machine, comprising:
receiving, by a server, an attribute from a plurality of lift device attributes;
receiving, by the server, a threshold value of the attribute;
locating, by the server, a lift device within a predefined area, wherein the lift device is associated with the attribute;
receiving, by the server, a value of the attribute associated with the lift device;
determining, by the server, if the value satisfies the threshold value of the attribute; and
in response to determining, by the server, that the value satisfies the threshold value, transmitting, by the server, instructions to the lift device to indicate that the value satisfies the threshold value of the attribute by at least one of:
indicating by an indicator associated with the lift device; or
identifying the lift device on an electronic device.

2. The computer-implemented method of claim 1, wherein the plurality of lift device attributes comprises at least one of a charging status, a charge level, a fuel level, a trouble code, a machine type, a machine reach, a machine age, and a machine operating hours.

3. The computer-implemented method of claim 1, wherein the predefined area is determined by a local mesh network.

4. The computer-implemented method of claim 1, wherein identifying the lift device on the electronic device comprises highlighting the lift device on a map displayed on the electronic device.

5. The computer-implemented method of claim 1, wherein locating at least one lift device further comprises:
transmitting, by the server, a request to one or more machines communicatively coupled to the server by a local mesh network for one or more attributes associated with the one or more machines;
in response to receiving, by the server, one or more attributes associated with the one or more machines, determining, by the server, if the one or more attributes associated with the one or more machines corresponds to the attribute received by the server; and
receiving, by the server, from the one or more machines, a location corresponding to each of the one or more machines.

6. The computer-implemented method of claim 1, wherein the indicator associated with the lift device is one of an audio emitter, a light emitter, and a haptic emitter.

7. The computer-implemented method of claim 1, further comprising:
in response to determining, by the server, that the value does not satisfy the threshold value, transmitting, by the server, instructions to the lift device to indicate that the value does not satisfy the threshold value of the attribute by at least one of:
indicating by the indicator associated with the lift device; or
identifying the lift device on the electronic device.

8. A system comprising:
a lift device;
a user device; and
one or more processors configured to execute steps including:
receiving from the user device an attribute from a plurality of lift device attributes;
receiving from the user device a threshold value of the attribute;
locating the lift device within a predefined area, wherein the lift device is associated with the attribute;
receiving from the lift device a value of the attribute associated with the lift device;
determining if the value satisfies the threshold value of the attribute; and
in response to determining that the value satisfies the threshold value, transmitting instructions to the lift device to indicate that the value satisfies the threshold value of the attribute by at least one of:
indicating by an indicator associated with the lift device; and
identify the lift device on an electronic device.

9. The system of claim 8, wherein the plurality of lift device attributes comprises at least one of a charging status, a charge level, a fuel level, a trouble code, a machine type, a machine reach, a machine age, and a machine operating hours.

10. The system of claim 8, wherein the predefined area is determined by a local mesh network.

11. The system of claim 8, wherein identifying the lift device on the electronic device comprises highlighting the lift device on a map displayed on the electronic device.

12. The system of claim 8, wherein locating the lift device further comprises:
transmitting a request to one or more machines communicatively coupled by a local mesh network for one or more attributes associated with the one or more machines;
in response to receiving one or more attributes associated with the one or more machines, determining if the one or more attributes associated with the one or more machines corresponds to the attribute received; and
receiving from the one or more machines a location corresponding to each of the one or more machines.

13. The system of claim 8, wherein the indicator associated with the lift device is one of an audio emitter, a light emitter, and a haptic emitter.

14. The system of claim 8, further comprising:
in response to determining that the value does not satisfy the threshold value, transmitting, by the one or more processors, instructions to the lift device to indicate that the value does not satisfy the threshold value of the attribute by at least one of:
indicating by the indicator associated with the lift device; and
identifying the lift device on the electronic device.

15. A computer-readable medium comprising a non-transitory storage memory configured to store machine-readable instructions that when executed by a processor instruct the processor to:
receive an attribute from a plurality of lift device attributes;
receive a threshold value of the attribute;
locate a lift device within a predefined area, wherein the lift device is associated with the attribute;
receive a value of the attribute associated with the lift device;
determine if the value satisfies the threshold value of the attribute; and
in response to determining that the value satisfies the threshold value, transmit instructions to the lift device to indicate that the value satisfies the threshold value of the attribute by at least one of:
indicating by an indicator associated with the lift device; and
identifying the lift device on an electronic device.

16. The computer-readable medium of claim 15, wherein the plurality of lift device attributes comprises at least one of a charging status, a charge level, a trouble code, a machine type, a machine reach, a machine age, and a machine operating hours.

17. The computer-readable medium of claim 15, wherein the predefined area is determined by a local mesh network.

18. The computer-readable medium of claim 15, wherein identifying the lift device on the electronic device comprises highlighting the lift device on a map displayed on the electronic device.

19. The computer-readable medium of claim 15, wherein locating at least one lift device further comprises:
transmitting a request to one or more machines communicatively coupled by a local mesh network for one or more attributes associated with the one or more machines;
in response to receiving one or more attributes associated with the one or more machines, determining if the one or more attributes associated with the one or more machines corresponds to the attribute received; and
receiving from the one or more machines a location corresponding to each of the one or more machines.

20. The computer-readable medium of claim 15, wherein the indicator associated with the lift device is one of an audio emitter, a light emitter, and a haptic emitter.
